(19) United States
(12) Patent Application Publication
(10) Pub. No.: US 2025/0019944 A1
(43) Pub. Date: Jan. 16, 2025

(54) MOTION INTERRUPTING WATER-SAVING FAUCET VALVE

(71) Applicants: WESLEY ANDREW WILMERS, San Diego, CA (US); DALTON WESLEY WILMERS, San Diego, CA (US); CONNOR GRAYSON WILMERS, San Diego, CA (US); DALE ALLEN CAMPER, San Diego, CA (US)

(72) Inventors: WESLEY ANDREW WILMERS, San Diego, CA (US); DALTON WESLEY WILMERS, San Diego, CA (US); CONNOR GRAYSON WILMERS, San Diego, CA (US); DALE ALLEN CAMPER, San Diego, CA (US)

(21) Appl. No.: 18/614,550

(22) Filed: Mar. 22, 2024

Related U.S. Application Data
(60) Provisional application No. 63/454,023, filed on Mar. 22, 2023.

(51) Int. Cl. E03C 1/04; E03C 1/02; F16K 31/60

(52) U.S. Cl. CPC E03C 1/0404; F16K 31/605; E03C 2001/026

(57) ABSTRACT

A motion interrupting water saving faucet valve helps users improve their water efficiency. This is achieved through the use of a soft stop that limits the flow rate of water through a faucet by interrupting the motion of the valve that controls the fluid flow. As a result, there will be multiple different flow rates a user can achieve depending on the needs of a given application. A lower flow rate is the result of the soft stop being engaged through the use of a detent mechanism. The higher rate is the maximum flow rate of a faucet and is easily achieved by a user overriding the soft stop. These different flow rates allow a user to reduce their water consumption because they can now choose between using half or full flow through any given faucet.

### RELATED APPLICATIONS

This application claims priority to U.S. Provisional Patent Application Ser. No. 63/454,023 for a “Motion-Interrupting Water Saving Faucet,” filed Mar. 22, 2023, and currently co-pending, the entirety of which is incorporated herein by reference.

### FIELD OF THE INVENTION

The present invention is a motion interrupting water saving faucet valve that improves the water efficiency of a faucet or other plumbing fixtures. The faucet valve itself has a feedback point built into it that allows a user to limit the flow rate through the faucet. However, the function of the feedback point allows a user to easily switch between high or low flow depending on the needs of a given task.

### BACKGROUND OF THE INVENTION

In the United States, there has been tremendous effort made to improve water efficiencies of various plumbing fixtures. Some notable efforts include the United States Energy Policy Act of 1992, which mandated the first maximum water efficiencies for plumbing fixtures in both residential and commercial buildings; and in 2016 the California energy commission approved new maximum flow rates for plumbing fixtures in response to the historic drought the state was dealing with at the time. It is estimated that these regulations, including others not named here, combine to save about seven billion gallons of water a day, which is enough to meet the water needs of seven cities that are of similar size to New York City.

Despite these massive improvements, there is still a significant amount of water that can be saved. There are scenarios when a faucet is in use and a user does not need the maximum flow rate. For example, if the flow rate of a faucet in a shower is 1.8 GPM and a user has an option to halve that flow rate, then over the course of a ten-minute shower that user will be able to save roughly twelve gallons of water per shower. If you expand those savings to include at least one shower a day over the course of a seven-day week, the amount of water saved jumps to ninety-four gallons. That savings will add up and greatly aid in water conservation efforts.

Therefore, there is a need in the art for a faucet valve that employs the use of a soft stop to let a user easily reduce their water consumption, is easily used, and comparatively cost effective.

### SUMMARY OF THE INVENTION

The present invention is a motion interrupting water saving faucet valve that operates to add an intermediate stop point to provide a natural point in the operation of the valve in which the valve is not fully open in order to prevent the complete opening of the valve and thus impede the flow of water. The impediment results in a lower flow rate from the faucet to assist a user in reducing their water consumption. In a preferred embodiment, when a user turns a faucet on, they will feel the handle hit a “feedback point.” This feedback point was designed so that it can be either a hard stop or a soft stop, so that the faucet delivers water at a lower flow rate then what it was designed for. Regardless, in either scenario it is easy for a user to override. If a user wants a higher rate of flow, then they will continue to engage the faucet handle until it turns past the feedback point. Further, if a user initially needs the full flow, but decides that they no longer need it then they can simply turn the valve back to the point where the feedback point is engaged. This is a process that can be repeated as many times as needed for any given task.

Generally speaking, the motion interrupting water saving faucet valve operates through the use of a valve body that has an actuator element and a detent mechanism. The actuator element itself has a speedbump installed onto it and is joined to a faucet handle through a linkage unit. When a user turns the faucet handle, the actuator element is moved until the speedbump hits the detent mechanism; otherwise known as the feedback point.

There are a handful of different embodiments currently disclosed in this application. The first is a lever actuated faucet that has the motion interrupting water saving faucet installed. In this embodiment a user will lift the lever handle until the feedback point is hit, which allows a user to consider the current flow rate. If more is needed, then a user can easily move the lever handle to the fully open position. The second embodiment is a quarter turn faucet valve that has the motion interrupting water saving faucet installed. As a user turns the handle towards the open position, they will eventually hit the feedback mechanism. However, if more fluid flow is desired, then a user can easily turn the handle to overcome the feedback mechanism, to the fully open position. In both embodiments, if a user initially requires the full flow, but realizes later on that a reduce flow will work, then they can easily move the handle to the feedback point.

The motion interrupting water saving faucet valve disclosed herein is a cost effective and simple solution to helping users greatly reduce their water footprint. Additionally, the present invention can easily be installed into existing fixtures, or be seamlessly integrated into faucets that are currently being produced by manufacturers.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A-1D is a section view of a non-limiting example that illustrates the basic concept behind the motion interrupting water saving faucet valve;

FIG. 2 is a user decision flow chart for a user of the motion interrupting water saving faucet valve;

FIG. 3A is a front view of the motion interrupting water saving faucet valve in use within a lever actuated faucet;

FIG. 3B is a section view providing a close-up view of the water saving faucet valve and the valve body;

FIG. 4 is a quarter turn faucet with a motion interrupting water saving faucet valve installed;

FIG. 5 is a section view of a quarter turn faucet with a motion interrupting water saving faucet valve; and

FIG. 6 is a top view of a quarter turn faucet with a motion interrupting water saving faucet valve.

### DETAILED DESCRIPTION OF THE INVENTION

The present invention disclosed is a motion interrupting water saving faucet valve that reduces the water consumption for various different types of faucets. It does so by having a motion interrupting mechanism installed that provides a physical interrupt in the faucet at a predetermined location to prevent the simple wide-open use of the faucet valve. When a faucet is turned on and opened until reaching the physical interrupt and the user is satisfied with the lower flow of water, then no more action is needed; however, if more flow is desired then, the user can easily overcome the motion interrupting mechanism by opening the faucet to the fully open position, and vice versa. Finally, the present invention can be easily installed onto existing plumbing systems, and provides an affordable solution to lowering the water footprint of a user.

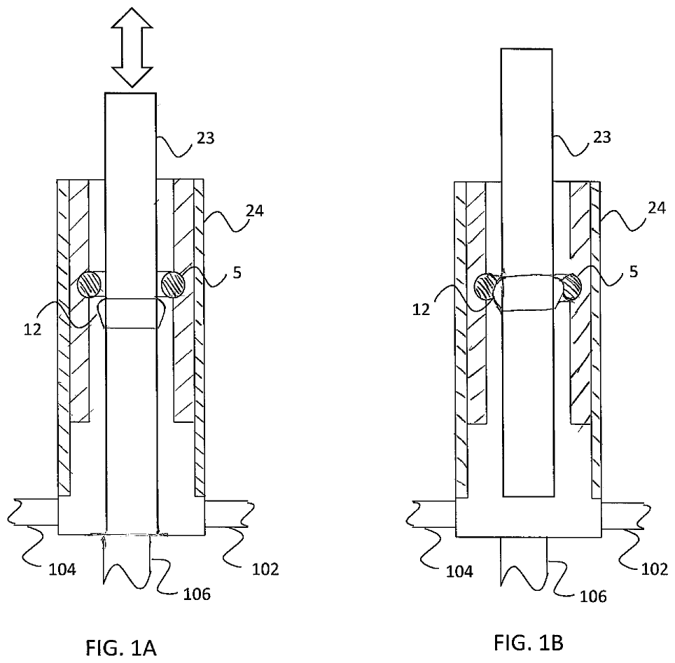

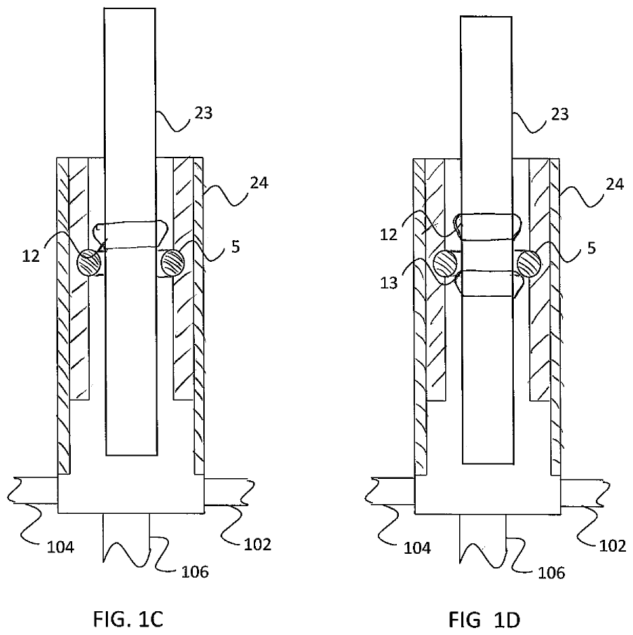

Referring initially to FIGS. 1A-1D, a non-limiting example of motion interrupting water saving faucet valve (water saving valve 100) in a basic embodiment is shown. These four figures are intended to illustrate the basics behind the operation of water saving valve 100. Water saving valve 100 is made up of a few critical components, namely actuator element 23, valve body 24, and a motion interrupter, raised lip 5. Valve body 24 in this example is made up of cold-water inlet 102, hot water inlet 104, and outlet 106.

In FIG. 1A, hot and cold water are both able to flow into valve body 24 via their respective inlets, but the resulting mixture cannot exit outlet 106 because actuator element 23 is in the closed position; sealing outlet 106. Actuator element 23 is in this position because the faucet is in the off position. FIG. 1B shows the faucet opened to a predetermined position, but the movement is halted once speedbump 12, that is located on actuator element 23, is impeded by raised lip 5. Raised lip 5 stops a user from moving a faucet to the fully open position, so while actuator element 23 is no longer sealing outlet 106, the water flow through outlet 106 is significantly impeded such that a lower flow rate occurs at the faucet opening. Here, motion is completely halted, but it is fully envisioned that other embodiments can include only momentarily slowing of actuator 23.

FIG. 1C shows a faucet in the fully open position should a user desire the full flow rate that a faucet is capable of. To get to this point, a user just simply opens the faucet to the fully open position by applying enough force for speedbump 12 to overcome the compressive force delivered by raised lip 5. Raised lip 5 was designed such that it does not require a tremendous amount of force to overcome, thus making use of water saving valve 100 widely accessible.

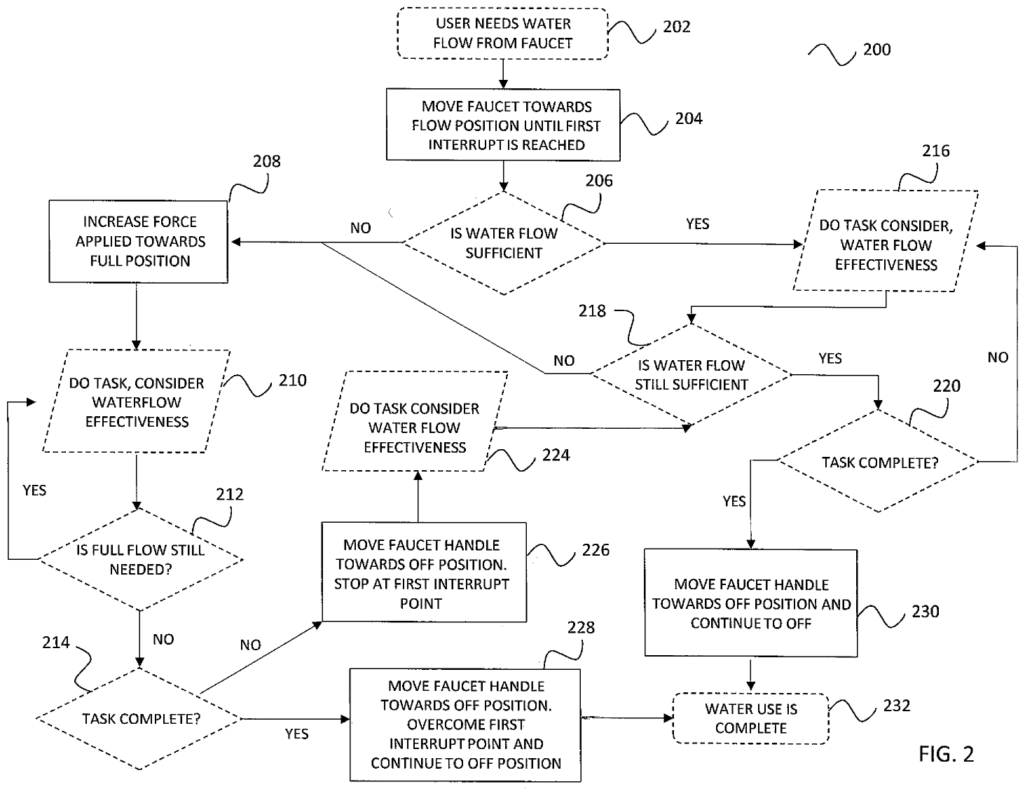

Referring now to FIG. 1D, actuator element 23 has a second speedbump 13 located on it some distance below speedbump 12. In this alternative embodiment there are now two different points of feedback for a user when using water saving valve 100. This will give a user even more flow rates to select from when they do not need the maximum flow rate. Additionally, it is important to note that in any of the disclosed embodiments the interrupting mechanism and feedback mechanism can be located anywhere in water saving valve 100. In a nonlimiting example for the feedback mechanism, second speedbump 13 was located at some distance below speedbump 12, but it could easily have been located closer or farther away from speedbump 12. However, in a nonlimiting example for the interrupting mechanism, raised lip 5 could be located anywhere higher up the interior of valve body 24 or lower. Referring now to FIG. 2, a user decision flow chart for operation of

the present invention is shown and generally designated as process 200. The process begins at step 202 when a user needs water flow from a faucet, and immediately proceeds to step 204 by opening the faucet until a first interrupt is reached. Step 206 is the first decision a user will need to make. If the water flow is sufficient, then a user proceeds to step 216 where the task is performed and the water flow effectiveness is considered. If the water flow is not sufficient, the user goes to step 208 and increases the force applied to the faucet until it reaches the full flow position.

For sake of discussion, it is assumed that the decision made after step 206 was no, and a user is now at step 208. At step 208 a user will increase the force applied to a faucet until it is in the fully open position. Once that is done, a user will then proceed to step 210 and consider the effectiveness of the water flow. At step 212, a user then considers whether the full flow is still needed, if that is a yes then the user will loop back to step 210 and reconsider the water flow effectiveness. If it is a no, a user then proceeds to step 214 to ask whether the task has been completed. If it is instead a yes, then a user moves to step 228 and starts to close the faucet and overcomes the first interrupt once it is encountered so that the faucet can be closed at step 232.

However, if a user at step 214 has not completed their task, but no longer needs the faucet fully open, then they can move to step 226 and turn the faucet handle to the off position until the first interrupt point is encountered. This will greatly reduce the water flow of the faucet, but still provide the user with the water flow they need for a task. While at the first interrupt point, a user will once again evaluate the water flow effectiveness at step 224 prior to determining whether the water flow is still sufficient at step 218. If the water flow is sufficient then a user will evaluate whether the task is complete at step 220. If the is complete, then a user will move the faucet handle to the off position at step 230 in order to complete their water use at step 232. However, if the water flow is not sufficient at step 218, then a user will loop back to step 208 and increase the force applied to the faucet so it is in the fully open position.

Reverting back to the first decision at step 206, the water flow is actually sufficient. When this is the case, a user will proceed to step 216 and consider the water flow effectiveness prior to asking whether the water flow is sufficient at step 218. If the flow is sufficient, then a user will then proceed to step 220 to ask themselves whether the task is complete, if it is not then the user will loop back to step 216. However, if the task is complete, user will follow steps 230 and 232 to close the faucet and complete their water use. However, if the water flow is not sufficient at step 218, then a user can go to step 208 and increase the force applied towards the faucet and fully open it.

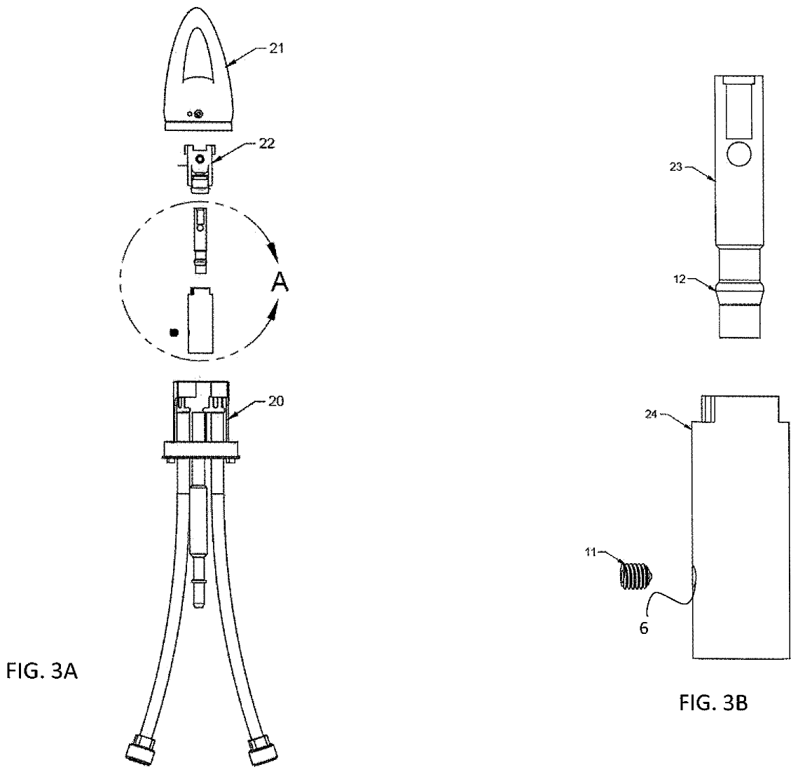

Referring now FIGS. 3A an 3B, an exploded view of a preferred embodiment of water saving valve 100 that is installed inside a lever faucet system is shown. In this embodiment mixing valve faucet 20 is coupled to the bottom of valve body 24, and the top of actuator mechanism 23 is coupled to actuator handle 21 through linkage 22. A close-up view of valve body 24 and actuator mechanism 23 can be seen in FIG. 3B. This view shows speedbump 12, which is a part of actuator mechanism 23, and positioned such that the opening of actuator handle 21 is halted when it hits screw-in interrupting mechanism 11, which screws into corresponding threaded aperture 6.

To use this embodiment, the user begins by moving attached actuator handle 21 to the open position, placing actuator element 23 in motion. As actuator element 23 passes a predetermined point (or points) of travel within valve body 24, its motion is interrupted by screw-in interrupting mechanism 11 and corresponding speedbump 12 (otherwise known as the feedback point). This halting of motion prompts a user to decide whether the water flow is sufficient for the task at hand. If the user prefers more water flow, they apply more force to actuator handle 21 towards the open position until the resistance generated by screw-in interrupting mechanism 11 is overcome and actuator element 23 motion resumes, allowing more water flow. If, however, the user is satisfied with the water flow, they stop applying force to actuator handle 21, and the faucet remains in water-saving mode. If the user is in water-saving mode and then decides they require higher water flow, they apply additional pressure to actuator handle 21 towards the open position until the resistance generated by the screw-in interrupting mechanism 11 overcome and the actuator element 23 motion resumes, allowing a higher volume of water flow.

Alternatively, if the user initially needed more water flow, but then subsequently determines that they now want a lower flow of water, they can get the lower flow rate by closing the actuator element 23 by moving actuator handle 21 towards the closed position until the motion is again interrupted by screw-in interrupting mechanism 11. When they wish to end water flow, they apply force to the actuator handle 21 causing the attached actuator element 23 to overcome the resistance generated by screw-in interrupting mechanism 11 and move towards the closed position until it reaches the fully closed position.

This embodiment of water saving valve 100 can easily be installed onto existing lever style faucet systems. All a user needs to do is disassemble an existing faucet, place valve body 24 inside mixing valve 20 and connect the actuator mechanism 23 to actuator handle 21 prior to reassembling the entire faucet system. This is an incredibly cost-effective way to reduce water consumption, while still preserving the ability to achieve the full flow rate of the lever faucet system. Additionally, the amount of force generated by screw-in interrupting mechanism 11 can be adjusted to provide more or less force by simply turning screw-in interrupting mechanism 11 in the corresponding direction.

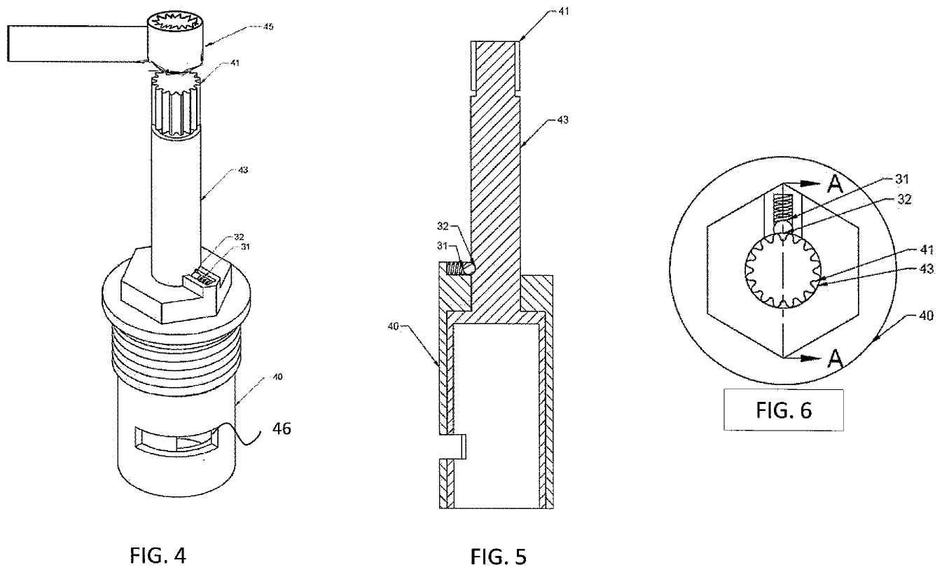

Referring now to FIG. 4, a top perspective view of an alternative embodiment of the present invention is shown. More specifically, water saving valve 100 is part of a new design for a conventional quarter turn style faucet. This embodiment has conventional handgrip 45 mated to splined handgrip interface 41 which is the end point of rotating cartridge valve stem 43. The unique feature of this embodiment is the use of a ball and spring detent system to reduce the fluid flow. Additionally, another unique feature of this embodiment is that the amount of feedback provided by the ball-and-spring 31 can be increased or lowered through the use of a spring with a higher or lower stiffness.

This can be better illustrated when discussing the section view displayed in FIG. 5 and the top view displayed in FIG. 6. In this view ball-and-spring 31 is fully engaged inside depression 32. As a user begins to rotate the cartridge valve 43 towards the open position by turning conventional handgrip 45 so that faucet aperture 46 of faucet 40 will start to open. Once faucet aperture 46 is opened a predetermined amount, cartridge valve 43 will be at a position such that ball-and-spring 31 is fully engaged inside depression 32. If a user desires more flow, then the engagement of ball-and-spring 31 and depression 32 can easily be overcome by applying more rotational force to conventional handgrip 45.

Alternatively, if the user is satisfied with the water flow, they stop rotating the cartridge valve 43 by ceasing rotational pressure on conventional handgrip 45 and the faucet remains in water-saving mode. If the user is in water-saving mode and then decides they require higher water flow, they apply rotational force to the cartridge valve 43 using conventional handgrip 45 towards the open position until the resistance generated by the ball-and-spring 31 and corresponding depression 32 is overcome and the cartridge valve 43 rotation resumes, allowing a higher volume of water to flow.

In another scenario where the user has initially chosen more water flow, but then determines they want a lower flow of water, they would begin closing the cartridge valve 43 by turning conventional handgrip 45 towards the off position until the rotation is again interrupted by the ball-and-spring 31 and corresponding depression 32, easily allowing them to adjust to a lower water flow. When they wish to end water flow, they apply rotational force to the cartridge valve 43 using the attached handgrip 45 towards the closed position until it is fully seated in the closed position.

While there have been two embodiments disclosed in the present application for water saving valve 100, there are a number of alternative embodiments that can incorporate the use of water saving valve 100.

For example, there are many styles of detent mechanisms other than the ones disclosed that could be used and implemented. Examples (not limited to): Wedge and notch, O-ring and groove, Garter spring and groove, cam and lobe, linkages. Additionally, there are also alternative methods to interrupt the travel instead of using the mechanical methods disclosed. This includes the use of electro-mechanical forces, magnetic forces, fluidic forces, and/or a dashpot system.

The travel of the actuator could be designed to be bistable.

The feedback along the actuator travel could be incorporated into the actuator handle assembly or the internal walls of the cartridge.

There are multiple ways to manufacture the feedback into the facet and/or cartridge, including but not limited to: threading, welding, casting, bonding, pressing, brazing, and others.

The reduced water flow point(s) could be incorporated into touchless actuator faucet

[symbol]

I claim:

1. A motion interrupting water saving faucet valve comprising:
a hollow valve body having a top with an aperture and a bottom with a water outlet;
a detent mechanism installed within the valve body interior at some distance above the water outlet;
an actuator mechanism within the interior of the valve body, having a proximal end that extends out of the aperture and a distal end that seals the mixed water outlet; and
a linkage that connects the proximal end of the actuator mechanism to a faucet handle, such that the faucet handle controls the movement of the actuator mechanism.

2. The motion interrupting water saving valve of claim 1, wherein a first speed bumped installed onto the actuator mechanism is installed onto a surface of the actuator mechanism.

3. The motion interrupting water saving valve of claim 1, wherein the detent mechanism is a raised lip.

4. The motion interrupting water saving valve of claim 1, wherein the detent mechanism is a screw that screws into the valve body at a treaded aperture.

5. The motion interrupting water saving valve of claim 1, wherein the actuator mechanism further comprises a second speedbump that is located some distance below the first speedbump.

6. The motion interrupting water saving valve of claim 1, wherein the detent mechanism is a depression.

7. The motion interrupting water saving valve of claim 6, wherein a ball-and-spring is installed onto the surface of the aperture mechanism that is sized to fit within the depression.
